(19) United States
(12) Patent Application Publication
(10) Pub. No.: US 2008/0214687 A1
(43) Pub. Date: Sep. 4, 2008

(54) Cross Linking Treatment of Polymer Membranes

(76) Inventors: Heinz-Joachim Muller, New South Wales (AU); Dongliang Wang, New South Wales (AU); Ashvin Kumar, New South Wales (AU)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/917,093

(22) PCT Filed: Jun. 20, 2006
(86) PCT No.: PCT/AU2006/000864

§ 371 Date: Dec. 10, 2007

(30) Foreign Application Priority Data
Jun. 20, 2005 (AU) 2002903237

(51) Int. Cl. C08J 9/36

(52) U.S. Cl. 521/54; 521/53

(57) ABSTRACT

Methods of forming a hydrophilic porous polymeric membrane which include preparing a porous polymeric membrane from a polymer blend which typically contains a hydrophobic non crosslinkable component (e.g. PVdF) and a component which is cross-linkable (for instance, PVP) and treating said porous polymeric membrane under cross linking conditions to produce a modified membrane with greatly improved water permeability and hydrophilic stability. Cross linking condition include chemical (e.g. peroxodisulfate species), thermal or radiation and/or combinations thereof. Non cross linked material may be washed out if desired.

### TECHNICAL FIELD

The invention relates to methods of preparing polymeric materials having enhanced properties in ultrafiltration and microfiltration applications, and to polymeric materials produced by such methods. More particularly, the invention relates to a cross-linking process to treat hydrophobic/hydrophilic membranes to greatly improve water permeability and hydrophilic stability. The invention also relates to hydrophobic/hydrophilic polymer blend membranes prepared by such processes.

### BACKGROUND ART

The following discussion is not to be construed as an admission with regard to the state of the common general knowledge.

Synthetic polymeric membranes are useful in a variety of applications including desalination, gas separation, filtration and dialysis. Membrane performance depends on factors such as the morphology of the membrane including properties such as symmetry, pore shape and pore size; on the chemical nature of the polymeric material used to form the membrane; and on any post-formation membrane treatment.

Membranes can be selected for specific separation tasks, including microfiltration, ultrafiltration and reverse osmosis, on the basis of these performance properties. Microfiltration and ultrafiltration are pressure driven processes and are distinguished by the size of the particle or molecule that the membrane is capable of retaining or passing. Microfiltration can remove very fine colloidal particles in the micrometer and submicrometer range. As a general rule, microfiltration can filter particles down to 0.05 μm, whereas ultrafiltration can retain particles as small as 0.01 μm and smaller. Reverse osmosis operates on an even smaller scale. Microporous phase inversion membranes are particularly well suited to the application of removal of viruses and bacteria.

A large membrane surface area is needed in order to accommodate a large filtrate flow. One technique to minimize the size of the apparatus used to house the membranes is to form a membrane in the shape of a hollow porous fibre. A large number of these hollow fibres (up to several thousand) are aligned, bundled together and housed in modules. The fibres act in parallel to filter a solution for purification, generally water, which flows in contact with the outer surface of all the fibres in the module. Under applied pressure, the water is forced into the central channel, or lumen, of each fibre while the microcontaminants remain in the space outside the fibres. The filtered water collects inside the fibres and is drawn off through the ends.

The fibre module configuration is a highly desirable one as it enables the modules to achieve a very high surface area per unit volume.

Regardless of the exact arrangement of fibres in a module, it is also necessary for the polymeric fibres themselves to possess the appropriate microstructure to allow microfiltration to occur.

Desirably, the microstructure of ultrafiltration and microfiltration membranes is asymmetric, that is, the pore size gradient across the membrane is not constant, but instead varies in relation to the cross-sectional distance within the membrane. Hollow fibre membranes are preferably asymmetric membranes possessing tightly bunched small pores on one or both outer surfaces and larger more open pores towards the inside of the membrane wall.

This asymmetric microstructure has been found to be advantageous as it provides a good balance between mechanical strength and filtration efficiency.

As well as the microstructure, the chemical properties of the membrane are also important. The hydrophilic/hydrophobic balance of a membrane is one such important property.

Hydrophobic surfaces are defined as “water hating” and hydrophilic surfaces as “water loving”. Many of the polymers used to cast porous membranes are hydrophobic polymers. Water can be forced through a hydrophobic membrane by use of sufficient pressure, but the pressure needed is very high (150-300 psi), and a membrane may be damaged at such pressures and generally does not become wetted evenly.

Hydrophobic microporous membranes are typically characterised by their excellent chemical resistance, biocompatibility, low swelling and good separation performance. However, when used in water filtration applications, hydrophobic membranes need to be hydrophilised or “wet out” to allow water permeation. This can include loading the pores with agents such as glycerol. Some hydrophilic materials are not suitable for microfiltration and ultrafiltration membranes that require mechanical strength and thermal stability since water molecules can play the role of plasticizers.

Currently, poly(tetrafluoroethylene) (PTFE), polyethylene (PE), polypropylene (PP) and poly(vinylidene fluoride) (PVdF) are the most widely used hydrophobic membrane materials. However, the search continues for membrane materials which will provide better chemical stability and performance while retaining the desired physical properties required to allow the membranes to be formed and worked in an appropriate manner. In particular, it is desirable to render membranes more hydrophilic to allow for greater filtration performance.

Microporous synthetic membranes are particularly suitable for use in hollow fibres and are produced by phase inversion. In one version of this process (DIPS, or diffusion induced phase separation), at least one polymer is dissolved in an appropriate solvent and a suitable viscosity of the solution is achieved. The polymer solution is cast as a film or hollow fibre, and then immersed in a precipitation bath of a non-solvent. This causes separation of the homogeneous polymer solution into a solid polymer and liquid solvent phase. The precipitated polymer forms a porous structure containing a network of uniform pores. Production parameters that affect the membrane structure and properties include the polymer concentration, the precipitation media and temperature and the amount of solvent and non-solvent employed. These factors can be varied to produce microporous membranes with a large range of pore sizes (from less than 0.1 to 20 μm), and which possess a variety of chemical, thermal and mechanical properties.

As well as the DIPS process described above, hollow fibre ultrafiltration and microfiltration membranes may also be formed by a thermally induced phase separation (TIPS) process.

The TIPS process is described in more detail in PCT AU94/00198 (WO 94/17204) AU 653528, the contents of which are incorporated herein by reference.

The TIPS procedure for forming a microporous system involves thermal precipitation of a two component mixture, in which the solution is formed by dissolving a thermoplastic polymer in a solvent which will dissolve the polymer at an elevated temperature but will not do so at lower temperatures. Such a solvent is often called a latent solvent for the polymer. The solution is cooled and, at a specific temperature which depends upon the rate of cooling, phase separation occurs and the polymer-rich phase separates from the solvent.

It is well recognized that the hydrophilic membranes generally suffer less adsorptive fouling than hydrophobic membranes. However, hydrophobic membranes usually offer better chemical, thermal and biological stability. In the field of water filtration membranes, it is highly desirable to combine the low-fouling properties of hydrophilic polymeric membranes with the stability of hydrophobic polymeric membranes.

In the present case the inventors have sought to find a way to hydrophilise membranes made from normally hydrophobic polymer, such as PVdF, to enhance the range of applications in which they may be used, while at the same time, retaining the good intrinsic resistance of the material to chemical, physical and mechanical degradation

PVdF is widely used due to its good resistance to oxidizing agents including chlorine, and ozone. It is also resistant to attack by most mineral and organic acids, aliphatic and aromatic hydrocarbons, alcohols and halogenated solvents. As well as polyvinylidene fluoride (PVdF), polysulfone (PS), polyethersulfone (PES) and polyacrylonitrile (PAN) are the dominant materials for making microfiltration/ultrafiltration membranes by phase inversion method. However, membranes fabricated from these polymers are hydrophobic and suffer from a severe fouling problem in water treatment applications.

Various methods have been employed in an attempt to hydrophilise PVdF porous membranes for water and/or wastewater uses. These methods include treating the PVdF membrane with a strong alkali such as NaOH or KOH to produce a reduced PVdF membrane which is then treated with an oxidizing agent to introduce a polar group to the membrane. PVdF membranes have been hydrophilised in this way by treatment with NaOH/Na₂S₂O₄, KOH/glucosamine, or KOH/H₂O₂.

An alternative method of chemical modification involves elimination of HF from the PVdF backbone using calcined alumina to give a double bond. A subsequent reaction with partially hydrolysed polyvinylacetate forms a hydrophilic membrane.

Chemical modifications such as the above are advantageous in that they usually result in the formation of covalent bonds, leading to the permanent introduction of hydrophilic groups to the PVdF membrane. The disadvantages typically include low yield, poor reproducibility and difficulties in scaling-up to commercial production. In addition, chemically modified PVdF membranes often lose mechanical strength and chemical stability.

A simple alternative technique to improve the hydrophilicity of hydrophobic membranes is to blend a hydrophilic polymer with hydrophobic polymer. Microporous polymeric ultrafiltration and microfiltration membranes have been made from PVdF (polyvinylidenefluoride) which incorporates a hydrophilising copolymer to render the membrane hydrophilic. Other hydrophilic polymers include cellulose acetate, sulfonated polymers, polyethylene glycol, poly(vinylpyrrolidone) (PVP) and PVP-copolymers etc. Due to its compatibility, PVP has been extensively used to make hydrophilic PVdF, PSf (polysulfone) and PES (polyethersulfone) porous membranes. While adding such copolymers does impart a degree of hydrophilicity to otherwise hydrophobic membranes, in some cases, the hydrophilising components can be leached from the membrane over time. For instance, water soluble hydrophilic components such as PVP are slowly washed out from the membrane during water filtration.

Polysulfone/PVP and PES/PVP membranes may be treated to improve hydrophilicity with peroxodisulphate/PVP aqueous solution. In this process, PSf/PVP membranes are immersed in a blend of PVP, PVP copolymer and one or more hydrophobic monomers and peroxodisulphate and then heated to 70° C. to 150° C. The resultant treated PSf/PVP membranes are water wettable.

Treatment of PSf/PVP or PES/PVP membranes with an aqueous solution of sodium persulfate and sodium hydroxide can dramatically reduce the amount of PVP extracted from the membranes.

Attempts have been made to improve the stability of PVP in PVdF membranes by forming a complex between PVP and metal (Fe³⁺). The complex is believed to form a network which entangles with the PVdF network in the membrane matrix.

The treatment of PES/PVP, PSf/PVP, PAN/PVP or PVdF/PVP membrane blends with hypochlorite can greatly improve their water permeability, which is believed to be as a result of the leaching of PVP from the membranes.

It is an object of the present invention to overcome or ameliorate at least one of the disadvantages of the prior art, or to provide a useful alternative.

### DESCRIPTION OF THE INVENTION

In a broad aspect, the invention provides a method of forming a hydrophilic polymer including:

i) preparing a polymer blend which contains a cross-linkable hydrophilic component; and

ii) treating said polymer blend to cross-link said cross-linkable component and form a hydrophilic polymer.

According to one aspect, the invention provides a method of forming a hydrophilic porous polymeric membrane including:

i) preparing a porous polymeric membrane from a polymeric blend which contains a component which is cross-linkable; and

ii) treating said porous polymeric membrane to cross-link said cross-linkable component

The term “hydrophilic” is relative and is used in the context of a refers to compound which when added to a base membrane component render the overall membrane more hydrophilic than if the membrane did not contain that compound.

Preferably, the cross-linkable component is hydrophilic. Preferably, the polymer or porous polymeric membrane also comprises a hydrophobic and/or not crosslinkable component.

In a particularly preferred embodiment the invention provides a cross-linking treatment process to treat hydrophobic/hydrophilic blend porous membranes for greatly increasing water permeability and hydrophilic stability.

Preferably, the porous membrane is a microfiltration membrane, or alternatively, an ultrafiltration membrane.

The processes of the present invention involves post-formation treatment of hydrophobic/hydrophilic polymer blend membranes. In one preferred embodiment, the cross-linking treatment is a chemical process, more preferably a chemical solution process. In an alternative preferred embodiment, the cross-linking treatment process is a radiation process. In a further alternative preferred embodiment, the cross-linking treatment process is a thermal process. The treatment processes can be a single treatment process or a combination of two or three processes. Preferably, two or three processes are used to obtain high performance membranes with high water permeability, good mechanical strength and good hydrophilicity.

The processes of the present invention can be used to treat dry membranes, wet membranes and rewetted membranes.

The process can be used to treat membranes in any form—singly, in a bundle or in a module.

If the cross linking process is a chemical process, the membrane is preferably contacted with a solution containing cross-linking agents to cross-link the hydrophilic polymer in the membrane. In an alternative chemical process, the membrane is contacted with a solution containing cross-linking agent and the cross-linking process is carried out in solution. Preferably, the membrane is first loaded with a solution containing cross-linking agent and then heated to allow cross-linking. Alternatively, the membrane is first loaded with a solution containing cross-linking agent and then treated with radiation, preferably gamma radiation, to allow cross linking.

Preferably, the contact with a solution containing cross-linking agent is by way of immersing the membrane in the solution containing cross-linking agent. Mixtures of one or more cross linking agents and/or one or more crosslinkable polymer may be used. Preferably, the cross linking is carried out substantially to completion.

In the chemical solution treatment process, the chemical solution contains a cross-linking initiator such as, for example, ammonium persulfate, sodium persulfate, potassium persulfate or mixtures thereof, and optionally an additive. The additive can be an inorganic acid, organic acid and/or alcohols and other functional monomers. The concentration of cross-linking agent is in the range of 1 wt % to 20 wt %, most preferably in the range 1 wt %-10 wt %. The concentration of an additive can be varied in the range of from 0.1 wt % to 10 wt %. Most preferable concentrations are from 0.5% to 5 wt %.

In a preferred embodiment of the process according to the invention, the chemical cross-linking is performed by heating the membrane loaded with the cross-linkable component, preferably at temperatures in the range of 50° C. to 100° C. Most preferably the membranes are kept in contact with the cross linking agent in solution during the heating process.

In a preferred embodiment of the process according to the invention, the membrane first absorbs the solution containing crosslinking agent and the resultant loaded membrane is then heated at the required temperature. In this process, the loaded membranes are heated in the wet state.

The treatment time can be from half hour to 5 hours depending on the treatment temperature. In general, the treatment time decreases with increasing treatment time.

The treatment may also involve soaking, filtering or recirculating to cross link the crosslinkable compound to the polymer matrix. Cross linking can also be carried out by gas or solid treatment.

In another preferred embodiment, the cross linking process is a radiation process wherein the membrane is exposed to gamma radiation, UV radiation or electrons to cause cross-linking of hydrophilic polymer. Radiation treatment can be completed with gamma radiation or UV radiation.

If cross linking is carried out by way of radiation, the radiation is preferably selected from gamma radiation, UV-radiation and electron-beam radiation. If the radiation is gamma radiation, the dosage is between 1 KGY and 100 KGY, more preferably between 10 KGY and 50 KGY.

In the gamma radiation treatment process, wet membranes, dry membranes, membrane bundles or membrane modules are treated under gamma radiation with a dose of 1 KYG to 100 KYG at the room temperature.

If the cross linking is by way of a thermal process, the thermal process is preferably conducted by heating the membrane at a temperature of between 40° C. and 150° C., more preferably 40 to 120° C., and more preferably between 50° C. and 100° C.

In a preferred embodiment of the process according to the invention, a combination process of the chemical solution and thermal process is applied. In this process, chemical solution treatment is conducted at a temperature of 50° C. to 100° C.

In a preferred embodiment of the process according to the invention, a combination process of the chemical process and gamma radiation is applied. The two modes of cross linking can be applied sequentially or simultaneously.

More preferably, the cross-linking treatment process is a combination of chemical solution process and thermal process. The two modes of cross linking can be applied sequentially or simultaneously.

Alternatively, the cross-linking process is a combination of chemical solution process and radiation process. The two modes of cross linking can be applied sequentially or simultaneously.

A combination of all three cross linking methods (chemical, thermal, radiation) may be used, in any combination of sequential or simultaneous modes.

The hydrophobic and/or not cross linkable polymers can be fluoropolymers, polysulfone-like polymers, polyetherimide, polyimide, polyacryolnitrile, polyethylene and polypropylene and the like. Preferable fluoropolymers are poly(vinylidene fluoride) (PVdF), and PVdF copolymers. Preferable polysulfone-like polymers are polysulfone, polyethersulfone and polyphenylsulfone.

The hydrophilic polymer may be a water soluble polymer or a water insoluble polymer.

The hydrophilic polymers are functional polymers which can be cross-linked by chemical, thermal and/or radiation method. Examples of water soluble hydrophilic cross linkable polymers include poly(vinylpyrrolidone) (PVP) and PVP copolymers, such as poly(vinylpyrrolidone/vinylacetate) copolymer, poly(vinylpyrrolidone/acrylic acid) copolymer, poly(vinylpyrrolidone/alkylaminomethacrylate) copolymer, poly(vinylpyrrolidone/alkylaminomethacrylamide) copolymer, poly(vinylpyrrolidone/methacrylamidopropyl trimethylammonium chloride) copolymer, polyethylene glycol, polypropylene glycol, polyelectrolyte, polyvinyl alcohol, polyacrylic acid or mixtures thereof.

The preferred hydrophilic polymers of this invention are water soluble poly(vinylpyrrolidone) (PVP) and PVP copolymers. The produce produced is a cross linked insoluble PVP embedded in the hydrophobic non-crosslinkable membrane polymer.

Examples of water insoluble hydrophilic polymers include cellulose acetate or sulfonated polymers.

The hydrophilic cross linking polymers can be present in any amount to give rise to the desired properties after cross linking. Preferably, they will be present in an amount of 1-50% by weight of the total membrane polymer. More preferably, they will be present in an amount of 5-20% by weight of the total membrane polymer. Most preferably they will be present in an amount of around 10% by weight of the total membrane polymer.

If chemical crosslinking is required, the cross-linking agents are preferably peroxodisulphate species, for example ammonium persulfate, sodium persulfate or potassium persulfate. More preferably, the chemical cross linking is carried out by way of aqueous peroxodisulphate-containing solution having a peroxodisulphate concentration of between about 0.1 wt % and 10 wt %, more preferably between about 1 wt % and 8 wt % and even more preferably between about 2 wt % and 6 wt %.

The cross linkable component (preferably a hydrophilic polymer and/or monomer) may be added at various stages in the preparation of the polymer, but is usually incorporated by addition into the polymer dope in membranes prior to casting. Alternatively, the cross linkable component may be added as a coating/lumen or quench during membrane formation. The cross linkable compound may be added in any amount, from an amount constituting the whole of the polymer down to an amount which produces only a minimal attenuation of the hydrophilicity/hydrophobicity balance.

Preferably, after crosslinking, the process also includes a step of leaching unbound or uncross-linked excess hydrophilic polymer. The excess unbound copolymer can be washed out with water or any other suitable solvent, for a predetermined time or to a predetermined level of leachate. It is possible that some cross linked material will be washed out, ie some oligomeric and lower polymeric material not fully embedded in the matrix of non-crosslinkable and/or hydrophobic polymer.

According to a further aspect, the invention also provides a method of functionalising a polymeric microfiltration or ultrafiltration membrane including:

i) preparing a porous polymeric microfiltration or ultrafiltration membrane which contains a component which is cross-linkable;

ii) treating said polymeric microfiltration or ultrafiltration membrane with a cross-linking agent to cross-link said cross-linkable component; and

iii) leaching un cross-linked cross-linkable component, if any.

The cross-linkable component is preferably hydrophilic.

As mentioned above, the present invention can be carried out upon any polymeric microfiltration or ultrafiltration membrane which contains cross linkable moieties, monomers, oligomers, polymers and copolymers which are capable of cross linking to produce a hydrophilised membrane.

Membranes of the present invention possess the properties expected of hydrophilic membranes. These include improved permeability and decreased pressure losses for filtration of any type, but in particular water filtration, such as filtration of surface water, ground water, secondary effluent and the like, or for use in membrane bioreactors.

According to a further aspect the invention provides a porous polymeric microfiltration or ultrafiltration membrane including a cross linked hydrophilic polymer or copolymer.

Preferably, the cross linked hydrophilic polymer or copolymer is integrated into a matrix of a porous microfiltration or ultrafiltration membrane also includes a non cross-linked and/or hydrophobic component.

Preferably, the membranes of the present invention are asymmetric membranes, which have a large pore face and a small pore face, and a pore size gradient which runs across the membrane cross section. The membranes may be flat sheet, or more preferably, hollow fibre membranes.

In another aspect, the invention provides a hydrophilic membrane prepared according to the present invention for use in the microfiltration and ultrafiltration of water and wastewater.

In another aspect, the invention provides a hydrophilic membrane prepared according to the present invention for use as an affinity membrane.

In another aspect, the invention provides a hydrophilic membrane prepared according to the present invention for use as protein adsorption.

In another aspect, the invention provides a hydrophilic membrane prepared according to the present invention for use in processes requiring bio-compatible functionalised membranes.

In another aspect, the invention provides a hydrophilic membrane prepared according to the present invention for use in dialysis.

The membranes of the present invention can be hollow fibre membrane, tube membrane or flat-sheet membrane. The membranes can be dry membranes, wet membranes or rewetted membranes. The membranes can be in the form of bundles or modules. The modules can be any type of modules such as hollow fibre module, spiral wound module etc.

In accordance with a preferred embodiment of the present invention, hydrophobic/hydrophilic blend membranes, particularly PVdF/PVP or PVdF/PVP copolymer blend membranes, are formed by a phase inversion process, particularly a diffusion-induced phase separation process, where PVdF, PVP, PVP copolymer, solvent and optional additives are mixed to prepare dope. This dope is cast into a flat-sheet membrane or extruded into a hollow fibre. After exchange with non-solvents in a quench bath and further washing in the wash bath, nascent wet membranes are formed. Wet membranes formed after washing but without drying are referred as the nascent membranes.

Dry membranes are prepared in two processes. In one process, the wet membrane is directly dried without any treatment with pore-filling agent. In an alternative process, wet membranes are first treated with pore-filling agents like glycerol and then dried.

Membranes which have been dried and then rewetted with water or other liquids are referred to as rewet membranes.

Membrane modules may be prepared from dry membranes or wet membranes.

Membranes treated with the method of the present invention were found to possess greatly improved water permeability, up to two to ten times that of non-treated membranes.

Membranes treated with the method of the present invention were also found to possess greatly improved hydrophilic stability. It is well recognized that hydrophilicity of membranes is very important in minimizing fouling in water filtration processes. PVP or PVP copolymer is water soluble, and PVP or PVP copolymer simply blended with hydrophobic polymer in membrane form can slowly leach out from the membranes. If PVP or PVP copolymer is rendered water insoluble by way of cross-linking, it is believed that PVP or PVP copolymer will be retained in the membranes for a longer period of time. In the prior art, it is known that the PSf/PVP, PES/PVP, PAN/PVP and PVdF/PVP blend membranes treated with the oxidizers such as Cl₂, NaOCl and H₂O₂ etc can improve water permeability. However, Cl₂, NaOCl and H₂O₂ cannot cross link PVP or PVP copolymers. Any increase in permeability of uncrosslinked blended membranes is generally as a result of the leaching of hydrophilic polymers from the membranes. As a result, the hydrophilicity of the treated membranes decreases. In contrast with the prior art post treatment process, in the present invention, water soluble PVP/copolymer or PVP becomes water insoluble after crosslinking treatment.

Without wishing to be bound by theory, it is believed that after cross-linking, the hydrophilic polymers are shrinkable and the increase in permeability is mostly caused by the opening of small pores due to the shrinkage of hydrophilic polymer. Further, it was surprisingly found that treatment does not affect the bubble point of the membrane.

It was found that the methods of the present invention slightly decreased the break extension, ie the membranes are more likely to break when stretched. After cross-linking treatment, the break extension decreases by about 5%-10% for the PVdF/PVP/VA blend membranes. However, with the consideration of the generally excellent elongation (150%-300%) of untreated PVdF membranes, the slight decrease of elongation does not affect the mechanical strength of the PVdF membranes under normal use conditions.

Importantly, the membranes of the present invention were found to retain high permeability even after drying. Without treatment with a wetting agent, the membranes prepared by the method of the present invention still exhibit high permeability when drying at room temperature.

Accordingly, the present invention relates to post-treatment processes to treat hydrophobic/hydrophilic polymer blend membranes to increase their water permeability and hydrophilic stability.

More specifically, the present invention relates to a method of treating a hydrophilic/hydrophobic blend porous polymeric membrane by crosslinking for increasing permeability and hydrophilic stability including:

i) preparing a porous polymeric membrane from a polymer blend which contains a component which is cross-linkable; and

ii) treating said porous polymeric membrane to cross-link said cross-linkable component.

The processes of the present invention are processes in which the hydrophilic polymers in the blend membrane are cross linked, there by increasing water permeability in some cases by a factor of 2 to 10 times higher than the corresponding untreated membranes. The post treatment processes of the present invention also render water soluble hydrophilic polymers water insoluble, thereby greatly improving the hydrophilic stability of the membrane due to the cross-linking of hydrophilic polymer.

Further, even when dried, membranes treated in accordance with the present invention still exhibit high water permeability even in the absence of treatment with pore filling agents like glycerol when the membranes are still wet. Importantly, the cross-linking treatment of the present invention does not affect the bubble point of the membrane and only has only minimal effect on the elongation of the membranes. The treatment processes are efficient, simple and cheap.

While the invention has been described with reference to particular embodiments, it will be understood by those skilled in the art that the inventive concept disclosed herein is not limited only to those specific embodiments disclosed.

### Experimental

Measurement of Water Permeability of Membrane Samples

The water permeability of a hollow fibre was determined with a small test cell. Each cell contained two hollow fibres with the length of 10-15 cm. The RO (reverse osmosis) water permeated from the shell side to the lumen side at a pressure difference of 100 kPa and a temperature of 25±1° C. Based on the water flow, the water permeability was calculated based on the outer diameter of the hollow fibre.

Measurement of Water Permeability of Membrane Modules

The membrane module normally contains 7,000-10,000 fibers with effective length of 1.1 m. The tap water flow was measured from the shell side to the lumen side at a pressure difference of 100 kPa and a temperature of 25±1° C. Based on the water flow, the water permeability was calculated based on the outer diameter of the hollow fibre.

Measurement of Ethanol Bubble Point

The hollow fibre in the test cell was placed in ethanol (95+%) for 0.5-1 min and gas pressure was increased until the presence of small bubbles was observed. This step acts to remove water or glycerol from the lumen and large pores of the hollow fibre. The pressure was then decreased to zero and held for about 0.5-1 min until the fibre is completely wet. Pressure was again increased slowly until the bubbles reappeared. The process was typically repeated two to three times, until a constant bubble point pressure was obtained.

### EXAMPLES

### Cross-Linking of PVP/VA Co-Polymer and PVP Aqueous Solution

### Example 1

An aqueous solution containing 10 wt % PVP/VA (vinyl acetate), 3 wt % FeCl₃ and 1.5 wt % (NH₄)₂S₂O₈ was prepared. The solution was heated at 100° C. for 10 hr. No insoluble gel formed.

### Example 2

An aqueous solution containing 10 wt % PVP K-90 in 1000 ppm sodium hypochlorite (NaOCl) was prepared. No insoluble gel formed after 5 days.

### Example 3

An aqueous solution containing 10 wt % PVP K-90 in 5 wt % ammonium persufate and 1000 ppm NaOCl was prepared. Heating at 90° C. for 2 hr did not produce an insoluble gel.

### Example 4

An aqueous solution containing 10 wt % PVP/VA copolymer and 1000 ppm NaOCl was prepared. No insoluble gel formed after 5 days.

Examples 2 to 4 demonstrate that NaOCl cannot cause PVP or PVP-copolymer to crosslink. The presence of hypochloride inhibited the cross-linking of PVP by persulfate. The increase in permeability of hydrophobic polymer/PVP blend membranes after hypochlorite treatment is thus not caused by the cross-linking of PVP. One possible reason is that the PVP blocking some smaller pores is being leached out by hypochlorite, a strong oxidizer. Alternatively, hypochlorite breaks down PVP which is easily washed out during the washing process.

### Example 5

An aqueous solution containing 10 wt % PVP/VA and 3 wt % (NH₄)₂S₂O₈ was prepared. An insoluble gel formed when the solution was heated at 100° C. for 1 hr.

### Example 6

An aqueous solution containing 10 wt % PVP/VA, 3 wt % ammonium persulfate and 3 wt % glycerol was prepared. A brown insoluble gel formed when the solution was heated at 90° C. for 1 hr.

### Example 7

An aqueous solution containing 10 wt % PVP/VA copolymer and 5 wt % ammonium persulfate was prepared. An insoluble gel was formed when the solution was heated at 70° C., 80° C. and 90° C. for 1-2 hr, respectively.

### Example 9

An aqueous solution containing 10 wt % PVP/VA copolymer and 5% ammonium persulfate was prepared. Heating at 60° C. for 1 hr did not lead to the formation of an insoluble gel.

Examples 5 to 9 indicate that PVP/VA copolymer can be crosslinked with persulfate at temperatures at or above 70° C. at a short time. During the heating process, PVP/VA molecules aggregate together. The insoluble gel phase produced and the water phase were readily separated upon cross linking.

### Example 10

An aqueous solution containing 10 wt % PVP/VA copolymer, 5 wt % ammonium persulfate and 0.5 wt % hydrochloric acid was prepared. An insoluble gel was formed at temperatures of 60° C., 70° C., 80° C. and 90° C., respectively.

### Example 11

An aqueous solution containing 10 wt % PVP/VA copolymer, 5 wt % ammonium persulfate and 1 wt % sulfuric acid was prepared. An insoluble gel was formed at temperatures of 60° C., 70° C., 80° C. and 90° C., respectively.

### Example 12

An aqueous solution containing 10 wt % PVP/VA copolymer, 5 wt % ammonium persulfate and 2 wt % sulfuric acid was prepared. An insoluble gel was formed at temperatures of 60° C., 70° C., 80° C. and 90° C., respectively.

Examples 9-12 demonstrate that the cross-linking reaction takes place in the presence of ammonium persulfate as a cross-linking agent at temperatures at or above 60° C. The addition of acid decreases the temperature required to carry out the cross-linking reaction. The insoluble gel formed is identical to the gel formed in Examples 5 to 9.

### Example 13

An aqueous solution containing 10 wt % PVP K-90 and 5 wt % ammonium persulfate was prepared. The aqueous solution became gel when the solution was heated at the temperature of 60° C., 70° C., 80° C. and 90° C. for 20-30 min, respectively.

### Example 14

An aqueous solution containing 10 wt % PVP K-90, 5 wt % ammonium persulfate and 1 wt % sulfuric acid was prepared. The aqueous solution became gel when the solution was heated at the temperature of 60° C., 70° C., 80° C. and 90° C. for 20-30 min.

Examples 13 and 14 demonstrate that PVP K-90 can be easily cross-linked with ammonium persulfate. The gel formed from PVP K-90 is different to the gel formed with PVP/VA copolymer. The whole PVP K-90/aqueous solution became gel.

### Example 15

An aqueous solution containing 10 wt % PVP K-30, and 5 wt % ammonium persulfate was prepared. Insoluble gel was not formed when the solution was heated at the temperature of 60° C., 70° C. and 80° C. for 2 hr, respectively. A very weak gel was formed when heating at 90° C. for 2 hr.

### Example 16

An aqueous solution containing 10 wt % PVP K-30, 5 wt % ammonium persulfate and 1 wt % sulfuric acid was prepared. An insoluble weak gel was formed when the solution was heated at the temperature of 60° C., 70° C. and 80° C. for 2 hr, respectively.

Examples 15 and 16 demonstrate that cross-linking of low molecule weight PVP (PVP K-30) is much more difficult than cross-linking of PVP K-90 and PVP/VA copolymer.

### Example 17

An aqueous solution containing 10 wt % PVP K-30 was prepared. An insoluble gel was formed under the gamma radiation with the dose of 35 kGy.

### Example 18

An aqueous solution containing 10 wt % PVP K-90 was prepared. An insoluble gel was formed with gamma radiation with the dose of 35 kGy.

### Example 19

An aqueous solution containing 10 wt % PVP/VA copolymer was prepared. An insoluble gel was formed under treatment with gamma radiation with the dose of 35 kGy.

Examples 17, 18 and 19 demonstrated that PVP K-30, PVP K-90 and PVP/VA copolymer can be cross-linked with gamma radiation without cross-linking agent. The whole aqueous solution became a gel after exposure to gamma radiation.

### Example 20

An aqueous solution containing 10 wt % PVP/VA copolymer and 1 wt % glycerol or 1 wt % NMP (N-methylpyrrolidone) was prepared. No insoluble gel was formed on exposure to gamma radiation with a dose of 35 kGy.

Example 20 demonstrated that PVP/VA copolymer can not cross-link in the presence of small amounts of glycerol or NMP.

### Treatment of Membrane Fibres in Chemical Solution

Various porous PVdF/PVP/VA and PVdF/PVP blend hollow fibre membranes were prepared from polymer blends of PVdF with PVP/VA and/or PVP K-90.

### Example 21

Wet fibres were immersed into (NH₄)₂S₂O₈ solution at various concentrations and heated at 100° C. for different times. The treated fibers were immersed into a 30 wt % glycerol solution for 2-3 hr and then dried at room temperature. Table 1 shows the resultant permeability (LHM/B=litres per hour per metre² per bar). The permeability of a corresponding sample not subjected to cross linking treatment was 340 LHM/bar.

TABLE 1
The properties of fibres treated in solution at different conditions

| | (NH₄)₂S₂O₈ | | | Permeability |
|---|---|---|---|---|
| Samples | (wt %) | Temp (° C.) | Time (min) | (LHM/B) |
| 1 | 0 | 100 | 60 | 581 |
| 2 | 4 | 100 | 60 | 1513 |
| 3 | 5 | 100 | 60 | 1579 |
| 4 | 5 | 100 | 60 | 2022 |
| 5 | 5 | 100 | 80 | 1488 |
| 6 | 3 | 100 | 30 | 1762 |

Thus the permeability of hollow fiber membranes cross-linked in accordance with the present invention was increased to about 3-6 times than that of the corresponding non-cross-linked fiber. The concentration of ammonium persulfate had little influence on permeability.

### Example 22

In order to assess the feasibility of implementing the present invention on a production scale, a wet thermal process was applied. In this process, the membrane was immersed into a solution containing the cross-linking agent at room temperature for some time. The cross-linking agent loaded membrane was taken out from the solution and heated in the wet. The membrane always kept wet in the heating process. The results are shown in table 4.

TABLE 4
The properties of fibres treated with wet thermal process at different
conditions

| | (NH₄)₂S₂O₈ | Temp. | Time | Perm. | BP (EtOH) |
|---|---|---|---|---|---|
| Samples | (wt %) | (° C.) | (min) | (LHM/B) | (kPa) |
| 1 | 0 | 100 | 30 | 234 | 250 |
| 2 | 5 | 100 | 30 | 1558 | 250 |
| 3 | 5 | 100 | 30 | 1607 | 250 |

There is nearly no difference between wet thermal treatment and solution treatment. The permeability of non cross-linked fibers decreased after heating in the wet thermal process. A comparison of bubble points (BP) of treated and non-treated fibers indicates that the cross-linking treatment does not change the bubble point of the fibers. This suggests that the increase in permeability was mainly caused by opening small pores due to shrinkage of PVP/VA copolymer.

### Example 23

When preparing water filtration membranes, the membranes are usually post treated with glycerol to wet out the membrane pores and prevent pore collapse after drying. It is surprising to note that the cross-linking treated PVdF/PVP/VA blend hollow fibres show good permeability even if the fibers are directly dried without subsequent glycerol treatment. Table 5 shows the results for fibres without glycerol treatment. All the samples were immersed into a cross linking chemical solution for 30 min and heated at 90° C. for 30 min. The samples were then dried at the room temperature.

TABLE 5
The properties of fibres without glycerol treatment before drying

| | (NH₄)₂S₂O₈ | Na₂S₂O₈ | | Perm. | BP (EtOH) |
|---|---|---|---|---|---|
| Samples | (wt %) | (wt %) | Process | (LHM/B) | (kPa) |
| 1 | 0 | 0 | No | 150 | 250 |
| 2 | 0 | 0 | Wet | 289 | 250 |
| 3 | 5 | 0 | Wet | 1558 | 250 |
| 4 | 5 | 0 | Wet | 1607 | 300 |
| 5 | 0 | 5 | Wet | 843 | 250 |
| 6 | 0 | 5 | Wet | 820 | 250 |
| 7 | 0 | 5 | Wet | 582 | 250 |
| 8 | 5 | 0 | Solution | 1579 | 250 |

Wet: wet thermal process

Based on the above results, glycerol treatment had little influence on the properties of the cross-liked fibers, but had serious negative effect on the permeability of the non cross-linked fibers. It is surprising to note that (NH₄)₂S₂O₈ as the cross-linking agent was much better than Na₂S₂O₈.

### Example 24

The wet fibres were immersed into the 10 wt % ammonium persulfate aqueous solution for different times. The wet fibres were then taken out and heated at 100° C. for half hour. The results are shown in Table 6

TABLE 6

| | Immersed Time | Perm. |
|---|---|---|
| Fiber No. | (sec) | (LHM/B) |
| 1 | 1 | 171 |
| 2 | 5 | 343 |
| 3 | 10 | 621 |
| 4 | 15 | 980 |

The results demonstrated that sufficient immersion time is necessary to achieve good results.

### Example 25

The wet hollow fibers were immersed into 10 wt % glycerol aqueous solution for 20 hr and completely dried at the room temperature. The dried samples were immersed in a solution containing 5 wt % ammonium persulfate and different concentrations of acids for 1 hr. The samples were removed and heated at different temperatures and different times. The results are shown in Table 7

TABLE 7

| | H₂SO₄ | HCl | Heating | Heating | Perm. |
|---|---|---|---|---|---|
| Samples | (wt %) | (wt %) | Tem. (° C.) | Time (hr) | (LHM/B) |
| 1 | 0.5 | | 95 | 0.5 | 1200 |
| 2 | 1 | | 95 | 0.5 | 1142 |
| 3 | | 0.5 | 95 | 0.5 | 1352 |
| 4 | | 1 | 95 | 0.5 | 952 |

Table 7 shows that the post-treatment of dried membranes also greatly increase water permeability.

### Example 26

Treatment of bundles. A bundle of 9600 PVdF hollow fibers of 160 cm length was immersed into 5 wt % ammonium persulfate solution for 1 hr. The bundle was taken out and heated at 100° C. for 1 hr. During the heating process, the fibers remained wet. The fibers were then dried. The water permeability of fibres was 800 LHM/bar.

### Example 27

Treatment of modules. Several modules containing 8000-9600 fibres with an effective length of around 110 cm were immersed into a solution containing 5 wt % ammonium persulfate and 1 wt % sulfuric acid for 1 hr. The module was heated at 90° C. for 3.5 hr. The results are shown in table 8.

TABLE 8

| | Before treatment | After treatment |
|---|---|---|
| Module No. | Perm (LHM/B)* | Perm. (LHM/B)* |
| CMF-S-1 | 160 | 400 |
| CMF-S-2 | 165 | 320 |
| CMF | 210 | 450 |

*Permeability is module permeability measured with river water
CMF-S: One side open
CMF: Two sides open

### Example 28

A polyethersulfone/PVP-VA blend hollow fibre membrane was prepared and treated with 5 wt % ammonium persulfate. The results are shown in Table 9.

TABLE 9

| | Before treatment | After treatment |
|---|---|---|
| Sample No. | Perm (LHM/B)* | Perm. (LHM/B)* |
| 1 | 43 | 277 |
| 2 | 41 | 168 |
| 3 | 38 | 146 |

### Example 29

The PVdF/PVP/VA wet hollow fibre was treated under gamma radiation at the dose of 35 KYG. The results are shown in Table 10

TABLE 10

| | Before treatment | After gamma treatment |
|---|---|---|
| Sample No. | Perm (LHM/B) | Perm. (LHM/B) |
| 1 | 348 | 680 |
| 2 | 227 | 537 |

### Example 30

The PVdF/PVP/VA wet hollow fibre was loaded with 5 wt % ammonium persulfate and 1 wt % sulfuric acid and treated with gamma radiation at the dose of 35 KGY. The results are shown in Table 11

TABLE 11

| | Before treatment | After gamma treatment |
|---|---|---|
| Sample No. | Perm (LHM/B) | Perm. (LHM/B) |
| 1 | 348 | 876 |

Example 29 and Example 30 indicates that the permeability increase of the membranes treated with gamma radiation is much lower than that of the membranes treated with peroxodisulphate solution. Without wishing to be bound by theory, it is believed that the major reason for this is that gamma radiation cannot cause shrinkage of PVP/VA copolymer which is present in the small pores.

### Example 31

The PVdF/PVP/VA hollow fiber was immersed into 5 wt % ammonium persulfate solution for 30 min and heated at 80° C. for 1 hr and then treated with gamma radiation of dosage of 40 KYG. The results are shown in Table 12.

TABLE 12

| | After treatment with | After treatment with gamma |
|---|---|---|
| | chemical solution | radiation |
| Sample No. | Perm. (LHM/bar) | Perm. (LHM/B) |
| 1 | 1111 | 1278 |
| 2 | 1181 | 1455 |

1. A method of forming a hydrophilic porous polymeric membrane comprising the steps of:
i) preparing a porous polymeric membrane from a polymer blend which contains PVdF or a PVdF copolymer and a component which is cross-linkable; and
ii) treating said porous polymeric membrane to cross-link said cross-linkable component.

2. A method according to claim 1 wherein the component which is cross-linkable is hydrophilic.

3. A method according to claim 1 wherein the component which is cross-linkable is selected from a group consisting of poly(vinylpyrrolidone) (PVP) and PVP copolymers, polyethylene glycol and combinations thereof.

4. A method according to claim 3 wherein the PVP copolymer is selected from a group consisting of poly(vinylpyrrolidone/vinylacetate) copolymer, poly(vinylpyrrolidone/acrylic acid) copolymer, poly(vinylpyrrolidone/alkylaminomethacrylate) copolymer, poly(vinylpyrrolidone/alkylaminomethacrylamide) copolymer, poly(vinylpyrrolidone/methacrylamidopropyl trimethylammonium chloride) copolymer, polyethylene glycol, polypropylene glycol, polyelectrolyte, polyvinyl alcohol, polyacrylic acid or mixtures thereof.

5. A method according to claim 3 wherein the poly(vinylpyrrolidone) (PVP) and PVP copolymers are water soluble.

6. A method according to claim 1 wherein the component which is cross-linkable is a water insoluble hydrophilic polymer.

7. A method according to claim 6 wherein the water insoluble polymer is cellulose acetate or a sulfonated polymer.

8. A method according to claim 1 wherein the porous polymeric membrane is a microfiltration membrane or ultrafiltration membrane.

9. A method according to claim 1 wherein the cross-linking treatment is a chemical process.

10. A method according to claim 9 wherein the cross-linking treatment is a chemical solution process.

11. A method according to claim 10 wherein the membrane is contacted with a solution containing cross-linking agents to cross-link the hydrophilic polymer in the membrane.

12. A method according to claim 11 wherein the chemical cross-linking is performed by heating the membrane containing the component which is cross-linkable at temperatures in the range of 50° C. to 100° C.

13. A method according to claim 9 wherein the cross-linking agent is a peroxodisulfate species.

14. A method according to claim 13 wherein the peroxodisulfate species is provided by ammonium persulfate, sodium persulfate, potassium persulfate or mixtures thereof.

15. A method according to claim 14 wherein the cross linking is carried out by way of an aqueous peroxodisulphate-containing solution having a peroxodisulphate concentration of between about 0.1 wt % and 10 wt %.

16. A method according to claim 15 wherein the cross linking is carried out by way of an aqueous peroxodisulphate-containing solution having a peroxodisulphate concentration of between about 1 wt % and 8 wt %.

17. A method according to claim 16 wherein the cross linking is carried out by way of an aqueous peroxodisulphate-containing solution having a peroxodisulphate concentration of between about 2 wt % and 6 wt %.

18. A method according to claim 9 wherein the cross linking is carried out by way of a solution which further contains an additive.

19. A method according to claim 18 wherein the additive is an inorganic acid, organic acid and/or alcohols and other functional monomers.

20. A method according to claim 18 wherein the concentration of additive is varied in the range of from 0.1 wt % to 10 wt %.

21. A method according to claim 19 wherein the concentration of additive is varied in the range of from 0.5% to 5 wt %.

22. A method according to claim 9 wherein the membrane first absorbs the solution containing crosslinking agent and the resultant loaded membrane is then heated at the required temperature.

23. A method according to claim 1 wherein the cross-linking treatment process is a radiation process.

24. A method according to claim 23 wherein the cross linking process is a radiation process wherein the membrane is exposed to gamma radiation, UV radiation or electrons to cause cross-linking of hydrophilic polymer.

25. A method according to claim 24 wherein radiation treatment is completed with gamma radiation or UV radiation.

26. A method according to claim 24 wherein the radiation is gamma radiation in a dosage is between 1 KGY and 100 KGY.

27. A method according to claim 24 wherein the radiation is gamma radiation in a dosage is between 10 KGY and 50 KGY.

28. A method according to claim 1 wherein the cross-linking treatment process is a thermal process.

29. A method according to claim 28 wherein the thermal process is conducted by heating the membrane at a temperature of between 40° C. and 150° C.

30. A method according to claim 28 wherein the thermal process is conducted by heating the membrane at a temperature of between 50° C. and 100° C.

31. A method according to claim 1 wherein the cross-linking treatment processes is a combination of two or more of a chemical process, a radiation process and a thermal process.

32. A method according to claim 31 wherein a combination of a chemical process and gamma radiation is applied.

33. A method according to claim 32 wherein the chemical process and gamma radiation is applied sequentially or simultaneously.

34. A method according to claim 1 wherein the cross linkable component is incorporated into the polymer dope in membranes prior to casting.

35. A method according to claim 1 wherein the cross linkable component is added as a coating/lumen or quench during membrane formation.

36. A method according to claim 1 wherein, after crosslinking, the process further includes the step of leaching unbound excess copolymer.

37. A method of functionalising a polymeric microfiltration or ultrafiltration membrane comprising the steps of:
i) preparing a porous polymeric microfiltration or ultrafiltration membrane which contains PVdF or a PVdF copolymer and a component which is cross-linkable;
ii) treating said polymeric microfiltration or ultrafiltration membrane with a cross-linking agent to cross-link said cross-linkable component; and
iii) leaching un cross-linked cross-linkable component, if any.

38. A porous polymeric microfiltration or ultrafiltration membrane including a cross linked hydrophilic polymer or copolymer.

39. A porous polymeric microfiltration or ultrafiltration membrane according to claim 38 wherein the cross linked hydrophilic polymer or copolymer is integrated into a matrix of a non cross-linked and/or hydrophobic component.

40. A porous polymeric microfiltration or ultrafiltration membrane according to claim 38 in the form of a hollow fibre membrane, tube membrane or flat-sheet membrane.

41. A porous polymeric membrane according to claim 38 which is a PVdF/PVP or PVdF/PVP copolymer blend membranes.

42. A porous polymeric membrane according to claim 41 formed by a diffusion-induced phase separation process.

43. A porous polymeric microfiltration or ultrafiltration membrane according to claim 38 in the form of a wet membrane.

44. A porous polymeric microfiltration or ultrafiltration membrane according to claim 38 in the form of a dry membrane.
